(19) United States
(12) Patent Application Publication
(10) Pub. No.: US 2024/0351774 A1
(43) Pub. Date: Oct. 24, 2024

(54) A PACK

(71) Applicant: BRITISH AMERICAN TOBACCO (INVESTMENTS) LIMITED, London (GB)

(72) Inventors: Michael CHURCHER, London (GB); Paul HODGES, London (GB)

(21) Appl. No.: 18/687,062

(22) PCT Filed: Aug. 25, 2022
(86) PCT No.: PCT/GB2022/052187

§ 371 Date: Feb. 27, 2024

(30) Foreign Application Priority Data
Aug. 31, 2021 (GB) 2112369.0

(51) Int. Cl. B65D 85/10; B23K 26/00; B23K 26/362; B23K 103/00

(52) U.S. Cl. CPC B65D 85/1045; B23K 26/0093; B23K 26/362; B23K 2103/40

(57) ABSTRACT

A pack including a base and a lid mounted to the base for rotation between open and closed positions, the lid being configured to separate from an upper edge of the base when rotated into the open position; wherein the base includes front and rear panels separated by side panels, wherein corners of the base between the front panel and side panels each include a right angled corner section and a chamfered or filleted corner section, the right angled corner section extending between the upper edge of the base and the chamfered or filleted corner section, and wherein corners of the base between the rear panel and side panels form a right angled corner along their full length.

### RELATED APPLICATIONS

The present application is a National Phase entry of PCT Application PCT/GB2022/052187 filed Aug. 25, 2022, which claims priority to GB Application No. 2112369.0 filed Aug. 31, 2021, each of which is hereby incorporated by reference in their entirety.

### TECHNICAL FIELD

The present invent relates to a pack, a blank for forming the pack and a method for making the pack.

### BACKGROUND

Tobacco industry products, such as cigarettes, are sold in packs. Known packs typically comprise a flip top lid and a U shaped inner frame. The inner frame extends from a base of the carton to grip the lid when the lid is closed.

### SUMMARY

In accordance with some embodiments described herein, in a first aspect there is provided a pack comprising a base and a lid mounted to the base for rotation between open and closed positions, the lid being configured to separate from an upper edge of the base when rotated into the open position; wherein the base comprises front and rear panels separated by side panels, and wherein corners of the base between the front panel and side panels each comprise a right angled corner section and a chamfered or filleted corner section, the right angled corner section extending between the upper edge of the base and the chamfered or filleted corner section, and wherein corners of the base between the rear panel and side panels form a right angled corner along their full length.

In accordance with some embodiments described herein, in a second aspect there is provided a card blank for forming the pack of claim 1.

In accordance with some embodiments described herein, in a third aspect there is provided a method of producing the pack of claim 1, the method comprising:

providing a blank of card material; forming fold lines comprising partial cuts in the card material, wherein forming the fold line comprises laser ablating the partial cuts into the car material; and folding the blank to form the pack.

### BRIEF DESCRIPTION OF THE DRAWINGS

FIG. 1 shows a pack having a filleted corner section;

FIG. 2 shows a pack having a chamfered corner section;

FIG. 3 shows the pack of FIG. 2 with hidden detail in dashed line;

FIG. 4 shows a blank for forming the pack of FIG. 1;

FIG. 5 shows a blank for forming the pack of FIG. 2;

FIG. 5 schematically shows a method; and

FIG. 7 shows an inner frame.

### DETAILED DESCRIPTION

The following relates to packaging for consumables. In some embodiments a consumable is an article comprising or consisting of aerosol-generating material, part or all of which is intended to be consumed during use by a user. A consumable may comprise one or more other components, such as an aerosol-generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

Aerosol-generating material is a material that is capable of generating aerosol, for example when heated, irradiated or energized in any other way. Aerosol-generating material may, for example, be in the form of a solid, liquid or gel which may or may not contain an active substance and/or flavourants. In some embodiments, the aerosol-generating material may comprise an “amorphous solid”, which may alternatively be referred to as a “monolithic solid” (i.e. non-fibrous). In some embodiments, the amorphous solid may be a dried gel. The amorphous solid is a solid material that may retain some fluid, such as liquid, within it. In some embodiments, the aerosol-generating material may for example comprise from about 50 wt %, 60 wt % or 70 wt % of amorphous solid, to about 90 wt %, 95 wt % or 100 wt % of amorphous solid.

The aerosol-generating material may comprise one or more active substances and/or flavours, one or more aerosol-former materials, and optionally one or more other functional material.

In some embodiments, the aerosol generating material comprises tobacco; and in some embodiments the consumable is a cigarette, cigarillo or cigar.

Hinged lid packs 1 and blanks 1′ for making hinged lid packs 1 according to embodiments of the invention are described below.

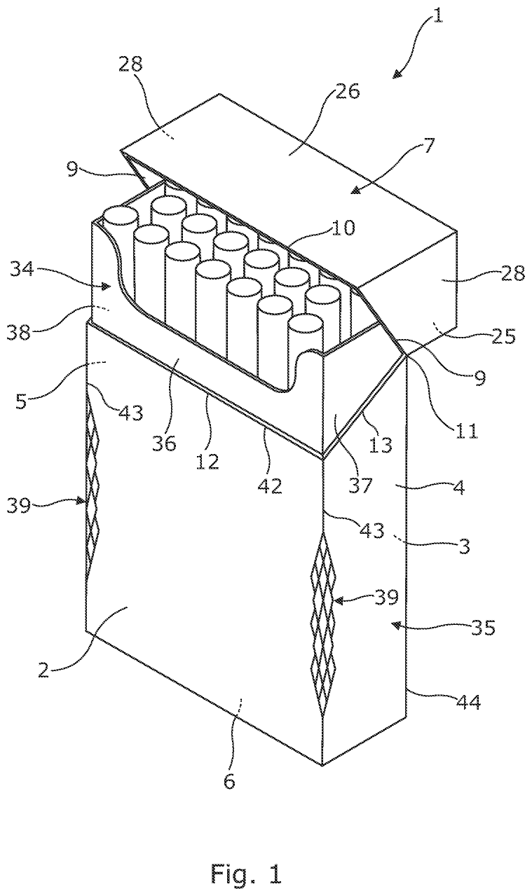

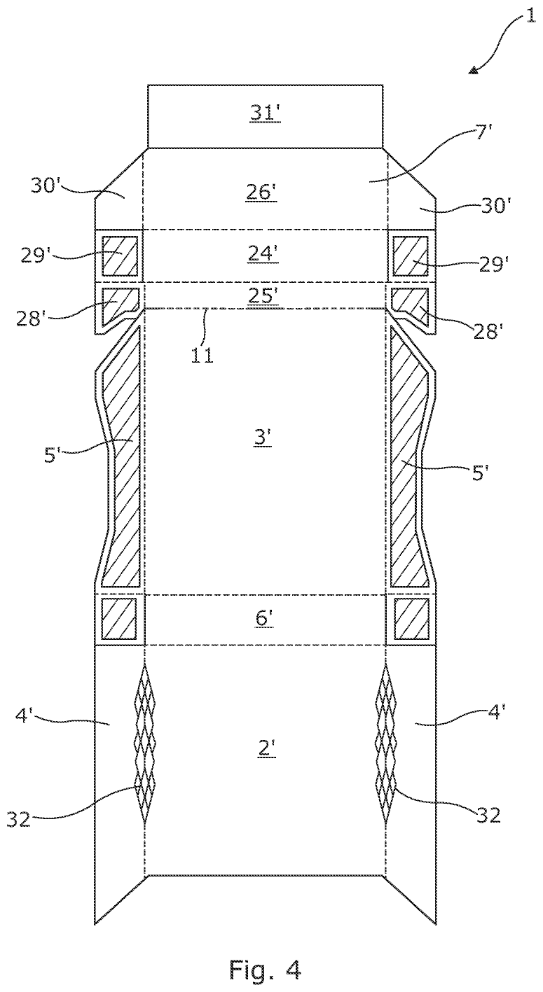

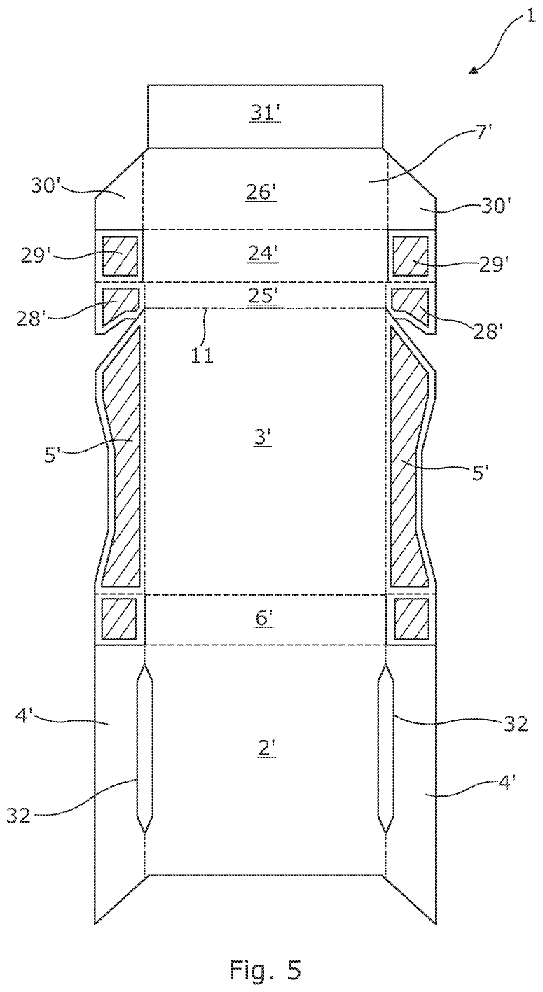

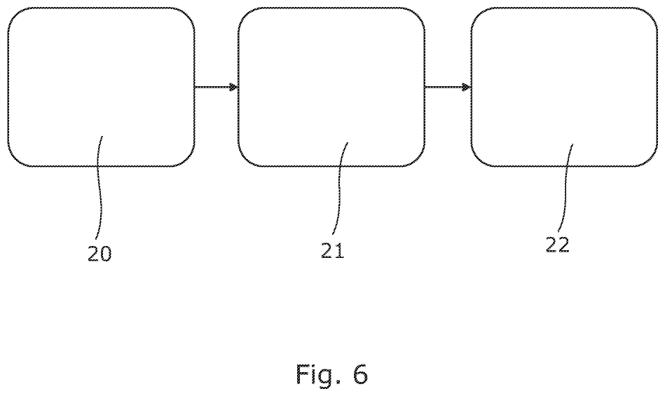

FIGS. 4 and 5 show blanks 1′ in accordance with some embodiments described herein. The blank 1′ is foldable to form the hinge lid pack 1 of any of FIGS. 1 to 3. Each blank 1′ comprises a front panel 2′, a rear panel 3′, side panels 4′, 5′ and a bottom panel 6′ for forming a base 35 of the hinged lid pack 1. The base 35 comprises corresponding front, rear, side and bottom walls 2, 3, 4, 5, 6. The blank 1′ further comprises a lid top panel 24′, a lid rear panel 25′, a lid front panel 26′ and re-entrant flaps 28′-30′ for forming a lid 7 of the pack 1. The lid 7 comprises corresponding lid rear, front and side walls 25, 26, 28. The lid 7 attaches to the base of the pack at hinge line 11.

Adjacent panels of the blank 1′ are separated by fold lines. As will be explained further below, to assembly the pack, selected panels are folded and glued together.

As illustrated by FIGS. 1 to 3, the lid 7 has sloping side edges 9 and a front edge 10 which in a closed position is lower than the hinge line 11. An upper edge 42 of the base 35, that is to say, upper edges 12, 13 of the front and side panels 2, 4, 5, are correspondingly shaped to provide a close fit when the lid 7 is closed. In the embodiments shown, and as well known in the art, the sloping arrangement of the lid 7 provides improved access to the cigarettes when the lid 7 is opened.

The pack 1 comprises a bundle of cigarettes wrapped in a barrier material (not shown). The barrier material comprises a tear off portion which separates along a line of weakening in the barrier material to provide access to the cigarettes in the conventional way. In the embodiments illustrated by FIGS. 1 to 3, the tear off portion has been removed so that the cigarettes are shown unobstructed by the barrier material. The barrier material may be made from a metallised paper or a paper/metal foil laminate, as is known in the art. In the illustrated embodiments, the bundle comprises a charge of 20 cigarettes formed from 3 rows of cigarettes, the front and back rows being 7 cigarettes wide and the middle row being only 6 cigarettes wide, so as to allow the cigarettes to lie in a close packed arrangement.

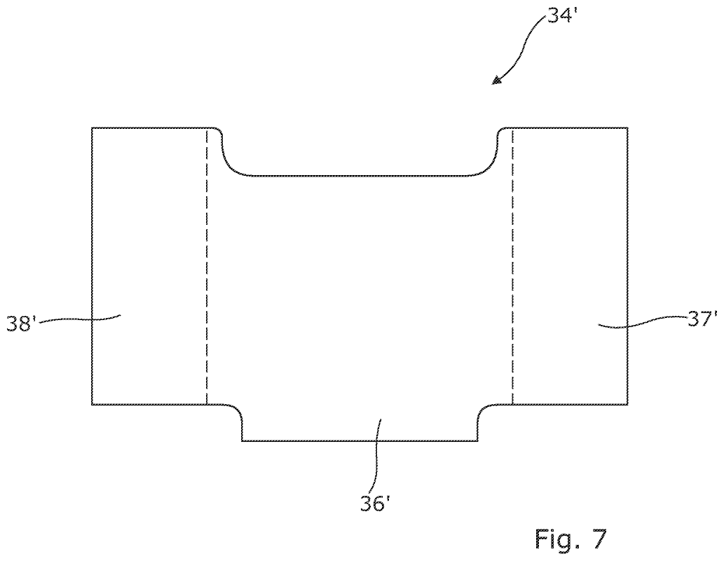

The pack 1 further comprises an inner frame 34 which encloses the bundle of cigarettes. A blank 34′ for forming the inner frame is shown in FIG. 7. The blank comprises a front panel 36′ and side panels 37′, 38′ that form corresponding front 36 and side walls 37, 38 of the inner frame when folded. The front wall 36 of the inner frame 34 sits flush against an inside face of the front wall 2 of the base 35 of the pack 1, with side walls 37, 38 of the inner frame 34 flush against the inside face of respective side walls 4, 5 of the base 35. The inner frame 34 extends from the base 35 so that, when the lid 7 is closed, the front wall 36 of the inner frame 34 sits flush against the inside face of the lid front wall 26, with the side walls 37, 38 of the inner frame 34 flush against the inside face of the lid side walls 28. Therefore, the inner frame 34 extends from base to grip the lid 7 in the closed position. The inner frame 34 may be attached to the base 35 by an adhesive. For example, an adhesive may be provided between the front wall 36 of the inner frame 34 and the front wall 2 of the base 35.

Each blank 1′ is formed of sheet material such as paper board. The paper board used in the pack may have a weight of 180-300 g/squ·m, more typically 200-280 g/squ·m, for example 240 g/squ·m, although a lighter material may be used, for example 215 g/squ·m. or even 200 g/squ·m. The paper board is typically of the order of 0.3 mm thick.

Each of the blanks 1′ illustrated in FIGS. 4 and 5 comprise partial cuts 32 in the blank 1′. Preferably in the inner surface of the blank. By inner surface of the blank 1′ it is meant the surface of the blank 1′ that becomes the inner surface of the pack 1 following folding of the blank 1′ to form the pack 1. By partial cut 32, it is meant any cut made in the blank 1′ that does not extend all the way through the blank 1′. In other words the depth of the partial cut 32 is less than the thickness of the blank 1′. For example, the partial cut 32 may be a score line or a line of weakening.

In the illustrated embodiments the partial cuts 32 extend substantially along the fold lines that delimit side panels 4′, 5′ from the respective front and rear panels 2′, 3′. The partial cuts are configured to form a chamfered or filleted corner section 39 between the front panel 2 and the side panels 4 when the blank 1′ is folded to form the pack 1.

In the embodiment of FIG. 4, the partial cuts 32 take the form of a diamond lattice 33 formed in the inner surface of the blank 1′. In other words, each partial cut 32 comprises multiple partial cuts in the inner surface that form a repeating array of elongate rhomboids. As a result, the area of the blank 1′ covered by the partial cuts 32 is more flexible than the surrounding area of the blank 1′. When the blank 1′ is folded to form the pack 1, the partial cuts 32 form a rounded edge or filleted corner between the front wall 2 and adjacent side walls 4, 5, as shown in FIG. 1. Each partial cut 32 tapers at either end so as to blend with the corners of the pack 1 that extend either side of the partial cuts 32. The corners of the pack either side the partial cuts 32 have a right angled section. By ‘rounded edge or filleted corner’, it is meant that the section 39 of the corner of the pack in the area of each partial cut 32 comprises a curved surface between the front wall 2 and adjacent side walls 4, 5 of the pack 1. By ‘tapers’ it is meant that the number of elongate rhomboid shaped cuts in the lattice 33 of each partial cut 32 reduces in number at either end of the partial cut 32. For example, in the illustrated embodiment, the lattice 33 is three rhomboid shaped cuts across at its widest point and terminates at either end in a single rhomboid shaped cut. However, the number of rhomboid shaped cuts at the widest point will depend on their individual size and can be adapted accordingly.

Where the partial cuts 32 are formed on the inner surface of the blank 1′, the diamond lattice 33 may be visible in relief in the outer surface of the pack 1. This may visually distinguish the pack 1. It shall be appreciated that by providing a repeating pattern on the inner surface of the blank 1′ the material removed by the partial cuts 32 makes up the difference between an arc length of outer surfaces of the filleted corner and an arc length of inner surfaces of the filleted corner. Although the illustrated embodiment uses a repeating pattern of rhomboids, other repeating patterns may be used to the same effect.

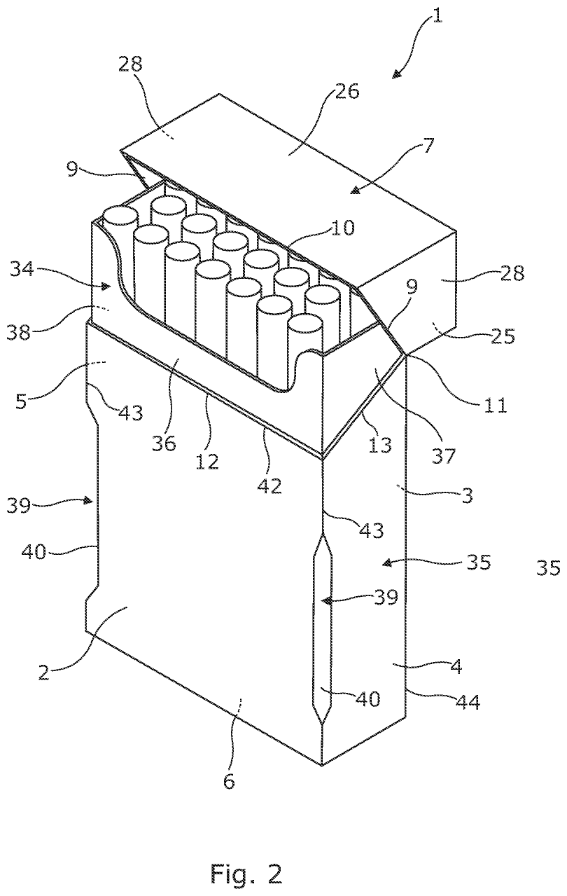

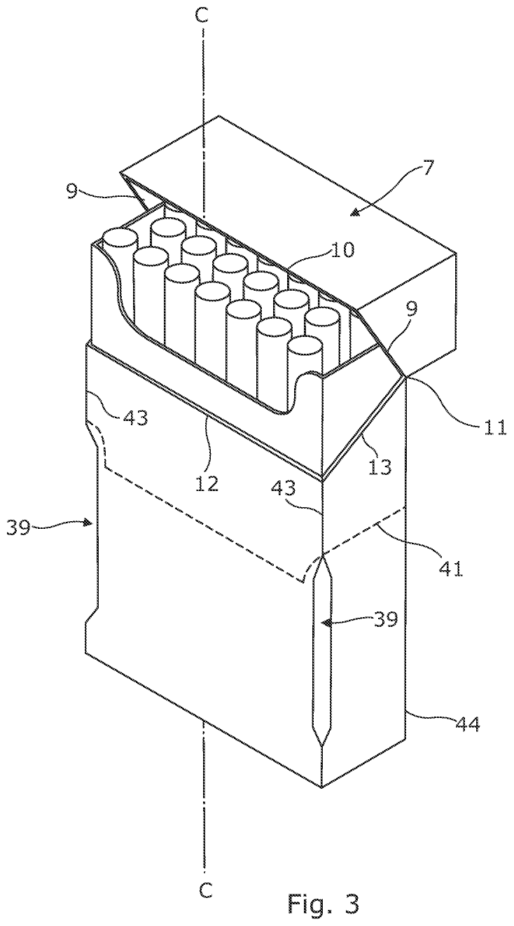

In the embodiment of FIG. 5, the partial cuts 32 trace the outline of additional intermediate panels. When the blank is folded, the intermediate panels 40′ form intermediate walls 40 between the front wall 2 and the adjacent side walls 4, 5, as shown in FIGS. 2 and 3. The intermediate walls extend obliquely between the front wall 2 and the adjacent side walls to provide chamfered corners between the front wall 2 and adjacent side walls 4, 5. The partial cuts 32 comprise tapered end sections to allow the intermediate walls to blend with the corners of the pack 1 that extend either side of the partial cuts 32.

The partial cuts 32 may be may be between 10% and 80% of the thickness of the blank 1′. In one embodiment, the partial cut 32 is 20% of thickness of the blank 1′. In another embodiment, the partial cut 32 is 30% of thickness of the blank 1′. In another embodiment, the partial cut 32 is 40% of thickness of the blank 1′.

The partial cuts 32 may be between 0.08 mm and 0.35 mm wide. In one embodiment the partial cut 32 is less than 0.15 mm wide.

It will be appreciated that the chamfered or filleted corner section 39 between the front wall 2 and the side walls 4, 5 of the pack 1 helps to locate the inner frame 34 within the base 35 of the pack 1 when the pack 1 is assembled. In particular, the cross sectional area of the base 35 is reduced in the region of the chamfered or filleted corner section 39 relative to the cross sectional area of the base 35 either side the chamfered or filleted corner section 39. A lower edge 41 of the inner frame 34 sits atop the chamfered or filleted corner section 39 which prevents the inner frame 34 from sliding down into the base of the pack 1 when the pack 1 is assembled, that is to say, before the adhesive between the base 35 and the inner frame 34 has dried.

By way of example, FIG. 3 shows the inner frame's 34 positioning within an assembled pack 1 of the configuration shown in FIG. 2. The lower edge 41 of the inner frame 34 is represented by a dashed line. So as to provide space for the inner frame 34, the chamfered or filleted corner section 39 is spaced from the upper edge 42 of the base 35. The corners of the pack either side the chamfered or filleted section 39 are herein referred to as right angled corner sections. Corners of the inner frame 34 locate in the right angled corner sections 43 that extend between the upper edge 42 of the base 35 and the chamfered or filleted sections 39.

To provide space for the inner frame 34, the right angled corner sections 43 that extend between the upper edge 42 of the base 35 and the chamfered or filleted sections 39 extend over 15% to 25% of the total length of their respective corner, that is, between 15% and 25% of the total length of each corner between the front wall 2 and side walls 4 of the base 35. In some embodiments, the right angled corner sections 43 extend over about 20% of the total length of each corner between the front wall 2 and side walls 4 of the base 35.

In accordance with the embodiments of FIGS. 1 to 3, it is preferable that the chamfered or filleted corner sections 39 are symmetrical about a centerline of the pack. Therefore, the spacing of each chamfered or filleted corner section 39 from the upper edge 42 of the base 35 is equal on either side of the pack 1. An example centerline C-C is shown in FIG. 3. The centerline extends in a plane coincident with the front wall 2 of the pack 1.

In accordance with the embodiments of FIGS. 1 to 3, corners 44 of the base 35 of the pack 1 formed between the side walls 4 and the rear wall 3 are right angled, that is to say, the corners 44 are not provided with a chamfered or filleted section and are right angled along their full length. Advantageously, this increases the stability of packs 1 when they are stacked together for packing and shipping by compensating for any decrease in stability that might be caused by the chamfered or filleted corner sections 39. In particular, packs are commonly stacked in array that is typically 2 packs by 5 packs, with the packs in each column of 2 being arranged front wall to rear wall. The packs of FIGS. 1 to 3 can be arranged for maximum stability by placing packs 1 in columns of 2, rear wall 3 to rear wall 3. Therefore, in any 2× stack, the chamfered or filleted sections 39 are facing outward for minimum effect on the stack stability.

A method of packaging cigarettes in the pack 1 will now be described with reference to FIG. 6. A magazine 20 contains a plurality of blanks 1′, 34′. The blanks 1′, 34′ are pre-formed with fold lines separating the different panels of the blank 1′ 34′. Individual blanks 1′ are conveyed sequentially to a cutting station 21 at which the partial cuts 32 are made in the blank 1′. Thereafter, the blanks 1′, 34′ are fed to a cigarette packaging machine 22 that is fed with a supply of cigarettes. The cigarette packaging machine 22 folds selected panels of the blank 1′ about the pre-formed fold lines so as to form the pack 1 and fills it with cigarettes wrapped in barrier material.

Referring to FIGS. 4 and 5, the front panel 2′ and the rear panel 3′ of the blank are connected by the base panel 6′. Side panels 4′, 5′ depend from the front and rear panels 2′, 3′ respectively. The lid depends from the rear panel 3′, opposite the base. The lid comprises a lid top panel 24′, a lid rear panel 25′, lid front panel 26′ and re-entrant flaps 28′-30′.

In the cigarette packaging machine 22, the front and rear panels 2′, 3′ are folded perpendicular to the base panel 6′ so as to face each other and form front and rear walls 2, 3 of the pack 1. The side panels 4′, 5′ are folded inwards to overlie one another and are glued together to form side walls 4 of the pack 1. The lid 7 is formed by folding the lid front panel 26′ and the lid rear panel 25′ perpendicular to the lid top panel 24′. The re-entrant flaps 28′-30′ are folded inwards and glued together to form side walls 28 of the lid. A tuck in flap 31′ depending from the lid front panel 26′ is folded onto an inside face of the lid front panel 26′ and glued down.

Also within the cigarette packaging machine, the inner frame blank 34′ is folded to form the inner frame 34 and is inserted into the base 35 of the pack 1 where it is adhered to the front wall 2.

In one embodiment, the partial cuts 32 are formed by a laser which is configured to scan across the blank 1′ as it is fed through the cutting station 21. The laser is configured to ablate a predefined pattern into the blank 1′. In an alternate embodiment, the partial cuts 32 are formed by rollers which are configured to crush cut a predefined pattern into the blank 1′ as it is fed through the cutting station 21. For example, the rollers may comprise an anvil roller with a smooth surface and a cutting roller comprising a blade. In such an example, the rollers are driven around respective parallel axes and are spaced to about the thickness of the blank 1′. The cutting roller comprises a blade which is configured to crush cut the predefined pattern into the blank against the anvil roller. Other means of creating partial cuts 32 will be apparent to the person skilled in the art. Irrespective of the method used to make the partial cut 32, the key objective is to break the surface of the blank 1′ along the line of the cut 32 to alleviate the surface tension around the cut 32. Where a laser is used, board material is removed by ablation to create a channel in the surface of the blank 1′. Where a crush cutting process is used, the surface of the board under the blade is broken and crushed to create a channel. Partial cuts are 32 distinct from embossing, where the surface of the board around the resulting embossment is not broken.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. A pack comprising a base and a lid mounted to the base for rotation between open and closed positions, the lid being configured to separate from an upper edge of the base when rotated into the open position;
wherein the base comprises front and rear panels separated by side panels, wherein corners of the base between the front panel and side panels each comprise a right angled corner section and a chamfered or filleted corner section, the right angled corner section extending between the upper edge of the base and the chamfered or filleted corner section, and wherein corners of the base between the rear panel and side panels form a right angled corner along their full length.

2. A pack according to claim 1, wherein the chamfered or filleted corner sections are symmetrical about a centerline of the pack.

3. A pack according to claim 1 or claim 2, wherein a cross sectional area of the base within the filleted or chamfered section is less than the cross section area within the right angled section.

4. A pack according to claim 1 or 2 further comprising an inner frame, the inner frame extending from the base of the pack to engage the lid when the lid is the closed position.

5. A pack according to claim 4, wherein the inner frame comprises a front panel and side panels depending from edges of the front panel; wherein the front and side panels of the inner frame abut an inside face of the front and side panels of the base, respectively; and wherein corners of the inner frame between the front and side panels of the inner frame locate in the right angled corner sections of the base.

6. A pack according to claim 4, wherein a lower edge of the inner frame locates against the chamfered or filleted corner section of the base.

7. A pack according to claim 1, wherein the chamfered or filleted corner section is a chamfered corner section comprising an intermediate wall that extends obliquely between the front wall and adjacent side walls of the base.

8. A pack according to claim 1, wherein the chamfered or filleted corner section is a filleted corner section comprising a curved surface that extends between the front wall and adjacent side walls of the base.

9. A pack according to claim 1, wherein the chamfered or filleted corner section tapers to blend the chamfered or filleted corner section with the right angled corner section.

10. A pack according to claim 1, formed from a folded blank of material.

11. A pack according to claim 10, wherein the blank comprises a paperboard material comprising a basis weight between 200 gsm and 270 gms.

12. A pack according to claim 10 or claim 11, wherein the blank comprises partial cuts made in the surface of the blank, the partial cuts being configured to from the chamfered or filleted section when the blank is folded to form the pack.

13. A pack according to claim 11, wherein the partial cuts take the form of a diamond lattice.

14. A pack according to claim 1, wherein the right angled corner sections extend between 15% and 25% of the total length of each corner between the front panel and side panels.

15. A method of producing the pack of claim 1, the method comprising:
providing a blank of card material;
forming fold lines comprising partial cuts in the card material, wherein forming the fold line comprises laser ablating the partial cuts into the card material; and
folding the blank to form the pack.
